(19) United States
(12) Patent Application Publication
(10) Pub. No.: US 2005/0223080 A1
(43) Pub. Date: Oct. 6, 2005

(54) Updatable user experience

(75) Inventor: Josh Thomas Gray, Kirkland, WA (US)

Correspondence Address: SENNIGER, POWERS, LEAVIT & ROEDEL, ONE METROPOLITAN SQUARE, 16TH FLOOR, ST. LOUIS, MO, 63102, US

(73) Assignee: Microsoft Corporation

(21) Appl. No.: 10/818,051

(22) Filed: Apr. 5, 2004

(51) Int. Cl. G06F 15/167; G06F 15/16

(52) U.S. Cl. 709/213; 709/215; 709/217; 709/227; 711/129; 711/118

(57) ABSTRACT

An updatable user interface (UI) for use with a host application that is executed by a client coupled to a data communication network. The client receives a UI resource for use by a client runtime library. A cache memory associated with the client and accessible by the client runtime library is updated with the received UI resource. A user interface component is rendered on the client in response to the client runtime library when the user requests a service provided by the host application.

### TECHNICAL FIELD

Embodiments of the present invention relate to the field of computer network environments. In particular, embodiments of this invention relate to integrating an updated user experience with a host application that requests authentication by a multi-site user authentication service.

### BACKGROUND OF THE INVENTION

Web services, such as those available at Internet sites, often provide information, products, services, and the like to their users. But many web services require that their users are authenticated before access will be granted to them. Those skilled in the art are familiar with authentication based on verifying a registered user's credentials (e.g., a login ID and associated password). Using a presently available multi-site user authentication system (e.g., Microsoft® .NET™ Passport single sign-in service), a web user can maintain a single set of credentials for accessing multiple, affiliated web servers or services. Such a system permits the user to establish a unique account identified by, for example, an e-mail address.

Those skilled in the art are also familiar with client application distribution models that rely on a discrete installation and/or deployment process where programs are installed directly on an end user's computer. These programs may interact with services across a network for portions of their functionality. But these programs may or may not be directly affiliated with the services providing this functionality. In addition, those skilled in the art are also familiar with techniques for aggregating content from different web services where one site or application physically hosts elements from another. Often referred to as cobranding, this content aggregation permits a more uniform user experience, particularly in the area of user authentication. For example, a number of hosting sites may display a common sign-in dialog embedded within cobranding content provided by site itself. Each hosting site's server typically serves a template file containing cobranding content while a central site provides the common feature (e.g., an authentication service provides the sign-in dialog).

Unfortunately, the look and feel as well as the core interaction flow of a user experience may change over time as, for example, an authentication service or other central site changes its behavior. This is particularly problematic where the host application provides the bulk of its functionality on the client side. Under these circumstances, aspects of the authentication or other common feature are coded into the client-side application. As a result, the application cannot easily respond to a desire to frequently update the authentication user experience and, thus, the user experience may suffer from out-of-date logos and branding of the central site, terms of use, process flow, etc. Moreover, a web process such as conventional cobranding is also lacking because it must be served live over one or more servers. Thus, updating the user experience in this instance requires a live connection and results in extensive traffic and a high load on the servers.

For these reasons, improved flexibility in providing a user experience that includes aspects independent of a host application is desired to address one or more of these and other disadvantages.

### SUMMARY OF THE INVENTION

Embodiments of the invention overcome one or more deficiencies in the prior art by providing, among other things, improved flexibility in providing a user experience that includes aspects independent of a host application. In one embodiment, a client-side component such as a client runtime library provides authentication services to the host application. Aspects of the invention enable an updated user experience to be integrated with the host application by initiating the client runtime library and receiving the latest user experience from a central site (e.g., a configuration server associated with an authentication server). In response to a request from the host application, embodiments of the invention create a child window and drive the user experience from a new user experience dynamic-link library. Thus, user interface content can represent virtually any desired user experience to track changes in the identity, look and feel, flow, etc. Moreover, the features of the present invention described herein are less laborious and easier to implement than currently available techniques as well as being economically feasible and commercially practical.

Briefly described, a method embodying aspects of the invention provides an updatable user interface for use with a host application that is executed by a client coupled to a data communication network for providing a service to a user. The method includes receiving a user interface (UI) resource for use by a client runtime library, updating a cache memory with the received UI resource, and causing a first user interface component to be rendered on the client. In this instance, the UI resource is received by the client via the network from a central server also coupled to the network. The cache memory is associated with the client and accessible by the client runtime library. According to the method, the first user interface component is rendered in response to the client runtime library when the user requests the service provided by the host application.

In another embodiment, a method of authenticating a user of a host application includes receiving, at a central server, a request for a user interface (UI) resource and sending the UI resource to a client via a data communication network. The UI resource is stored in a cache memory associated with the client and accessible by a client runtime library. The method also includes receiving authentication credentials from the user and comparing the received credentials with authentication information maintained in an authentication database to authenticate the user. According to the method, the authentication credentials are received in response to a first user interface component rendered on the client when the user requests the service provided by the host application. The first user interface component is based on the UI resource and managed by the client runtime library.

Yet another embodiment of the invention involves a data structure including a client runtime library for use with a host application and a user interface (UI) resource for use by the client runtime library. The host application is executable by a client coupled to a data communication network for providing a service to a user and the UI resource is received by the client via the data communication network from a central server also coupled to the network. In addition, the data structure includes a browser for rendering a first user interface component on the client based on the UI resource. The browser is responsive to the client runtime library to render the first user interface component when the user requests the service provided by the host application.

Computer-readable media having computer-executable instructions for performing methods of preventing spoof attacks embody further aspects of the invention.

Alternatively, the invention may comprise various other methods and apparatuses.

Other features will be in part apparent and in part pointed out hereinafter.

### BRIEF DESCRIPTION OF THE DRAWINGS

FIG. 1 is a block diagram illustrating an exemplary network environment in which the present invention may be utilized.

FIGS. 2, 3, and 4 illustrate exemplary user interfaces having sign-in dialogs according to embodiments of the invention.

FIG. 5 is an exemplary flow diagram illustrating process flow according to one embodiment of the invention.

FIG. 6 is a block diagram illustrating exemplary components of a computer for use in the system of FIG. 1.

Corresponding reference characters indicate corresponding parts throughout the drawings.

### DETAILED DESCRIPTION OF THE INVENTION

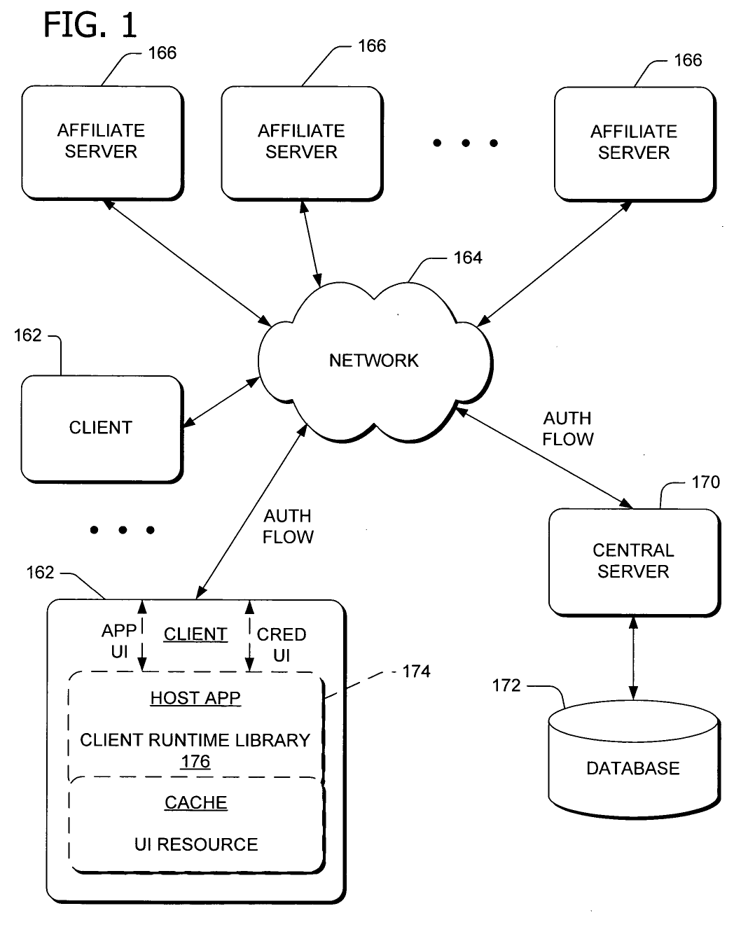

Referring now to the drawings, FIG. 1 illustrates an exemplary network environment in which the present invention may be utilized. The invention relates to integrating an updated user experience with a host application that requests common user experience elements from a central site (e.g., authentication by a multi-site user authentication service). For purposes of illustration, aspects of the invention are applicable to a distributed, multi-site user authentication service (e.g., Microsoft® .NET™ Passport sign-in service). Such service provides a user with the ability to access one or more participating web sites or resources with a single sign-in. Although the participating sites (referred to herein as “affiliates” or “affiliate sites”) maintain control over permissions, they use the authentication service rather than hosting and maintaining their own proprietary authentication systems. Those skilled in the art will note that although the invention is described in terms of a multi-site user authentication system, the inventors contemplate that the invention is operable with any type and number of distributed systems, including authentication systems.

In FIG. 1, one or more clients 162 are coupled to a data communication network 164. In this exemplary embodiment of the invention, the network 164 is the Internet (or the World Wide Web). However, the teachings of the present invention can be applied to any data communication network. Multiple affiliate servers 166 are also coupled to network 164. The affiliate servers 166 may be referred to as “web servers” or “network servers” generally.

A central server 170 coupled to network 164 allows communication between itself, the clients 162, and/or the web servers 166. FIG. 1 further illustrates a database 172 coupled to server 170. The database 172 contains information (i.e., credentials) necessary to authenticate a registered user of one of the clients 162 (as well as other users on the network). Although database 172 is shown in FIG. 1 as a single storage unit separate from central server 170 for convenience, it is to be understood that in other embodiments of the invention, database 172 may be one or more memories contained within or separate from server 170. In a federated environment, for example, a plurality of servers 170 may be used to provide authentication, profile management, and the like.

In operation, one or more clients 162 can access affiliate servers 166 via network 164. Although sometimes referred to as an “authentication server” in connection with FIG. 1, the central server 170 in the illustrated embodiment may also be a web server capable of interacting with other web servers. In one example, server 170, clients 162, and/or servers 166 communicate data among themselves using the hypertext transfer protocol (HTTP), a protocol commonly used on the Internet to exchange information. In an alternative embodiment, the implementation uses Simple Object Access Protocol (SOAP) encoded in XML riding on an HTTP transport. It is to be understood that the actual protocol is merely exemplary and is not a requirement.

Aspects of the present invention are particularly useful where a host application 174 on one of the clients 162 provides the bulk of its functionality on the client side. Under these circumstances, aspects of the authentication or other common feature are coded into the client-side host application 174 of FIG. 1. That is, executable code installed at the client provides functionality. The nature of the code being installed at client 162 makes it less easy to update if necessary than an application that is served from a server. Advantageously, embodiments of the invention permit improved flexibility in providing a user experience that includes aspects independent of host application 174. In other words, the user experience is much less likely to include out-of-date logos and branding of the central site, terms of use, process flow, etc.

In the context of at least one embodiment of the present invention, host application 174 executed on client 162 hosts elements from central server 170. For example, host application 174 initiates a client runtime library 176 and receives an updated dynamic-link library (DLL) from the authentication server (i.e., central server 170 ) for driving its authentication sign-in user experience. According to one embodiment, when host application 174 requests authentication, it creates a child window and drives its user experience from this new user interface DLL (e.g., UI DLL), also referred to herein as a UI resource. In other words, aspects of the invention involve a mixed user experience in which the user supplies credentials and interacts directly with a user interface presented by the client runtime that is an integrated part of the overall user interface of the client application.

The server 170, as described herein, may be part of an authentication service that authenticates a user of client computer 162. In this embodiment, client 162 requests of the client runtime library 176 an authenticated identity. Client runtime library 176 interacts with the user as necessary using its cached UI resources to drive the user interaction to collect any necessary credentials. Client runtime library 176 also communicates these credentials to central server 170. Central server 170 compares these credentials, or proof of possession of these credentials if not directly presented, to information in its database 172 and responds to client runtime library 176 with status of the authentication request. For instance, the client runtime library 176 takes additional action to ultimately achieve authentication based on this feedback from central server 170. This additional action may include additional interaction with the user based on the cached UI resources. If the user is successfully authenticated, an appropriate authentication is handled and status is returned to the application of client 162. Tokens extracted from this authentication state returned via client runtime library 176 from the central server 170 may be presented by client 162 to appropriate affiliate server 166 to achieve authenticated access from the client application to the protected resources.

The user interfaces for credential collection support adequate flexibility for the application to effectively integrate it with its own look and feel. This is similar to the cobranding capabilities in web-based authentication scenarios, except that the source of the customization in the case of the client runtime library 176 is hosting application 174 rather than the remote resource.

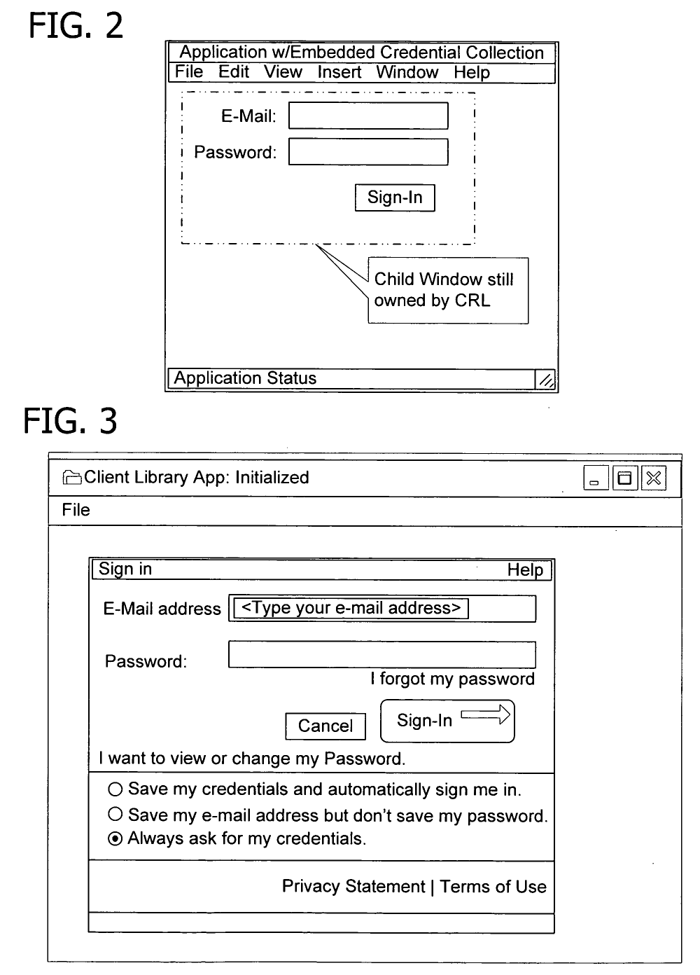

FIG. 2 illustrates an exemplary application user interface (UI) including a form field for the user to provide authentication credentials. In this instance, the form field is located within a frameless child window managed by client runtime library 176 rather than a stand-alone form field (i.e., a framed parent window). The client runtime library 176 of host application 174 maintains control of the child window based on the updated DLL while the host application 174 itself manages the area surrounding the child window.

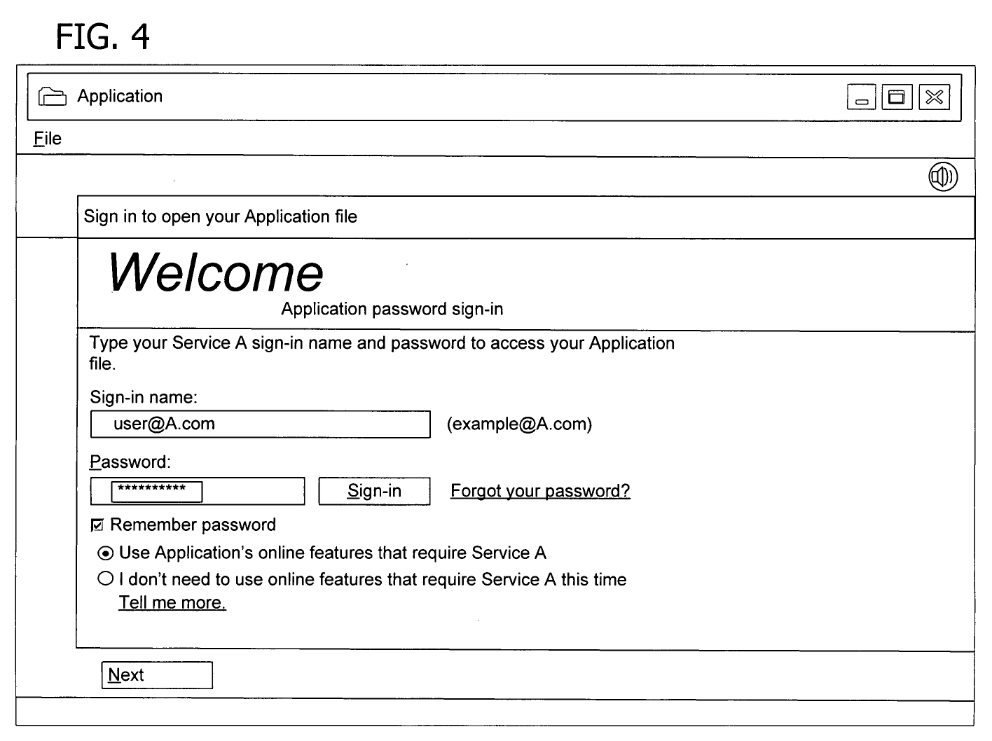

FIGS. 3 and 4 provide further examples of a nested authentication UI within host application 174. According to the client runtime architecture, a component or portion (i.e., the child window) of the user experience authenticating the user is a representation and process driven by a securely cached portion managed by the authentication client runtime library 176. The host application 174 manages the area surrounding the library's integrated user experience, namely, the area outside the child window. FIG. 3 shows a simple host application 174 that displays this surrounding area as a blank background to more clearly denote the difference whereas FIG. 4 provides exemplary host application content in this surrounding area. Those skilled in the art will recognize that host application 174 is free to display essentially anything around the authentication user experience. In this embodiment of the invention, the area surrounding the child window, referred to sometimes as a parent window, constitutes another portion or component of the user interface.

As described above, client runtime library 176 supports a flexible user interface allowing the user experience to be periodically updated from central server 170. The client runtime library UI supports a frameless child window for credential collection while hosting application 174 maintains complete control of the containing windows and can control the look and feel of these windows to create any of the common user interaction models. An embedded child window can be used to create two fundamentally different user experiences based on whether the hosting application creates a framed parent window or embeds the client runtime library UI into its window (see FIGS. 2-4). It is to be understood that the child window can also be embodied by a pop-up UI element.

According to the invention, in one embodiment client runtime library 176 is a client-side component that cooperates with central server 170 to provide, for example, authentication services to host application 174. In doing so, it communicates with the user to collect information (e.g., credentials), inform the user of the progress of his or her authentication, and to help the user resolve any issues that may be standing in the way of their authentication (e.g., if the authentication service needs the user to agree to new terms of use per some legal change, the client runtime can alter the flow to require this consent during the authentication process).

Advantageously, the user experience DLL permits authentication identities (e.g., FIG. 4) that are representative of an online service experience having user experience, brand affinity, and changing authentication functionality independent of host application 174. In contrast, a purely desktop identity authentication scenario cannot accommodate the potentially changing nature of the authentication experience in a thick client, or smart client, scenario. Embodiments of the present invention provide a client runtime library that supports secure download and caching of a modified user experience based on web technologies. An important aspect of the invention supports not only secure download but secure storage in cache. In this manner, embodiments of the invention take steps to maintain the integrity of the cached UI DLL during transit as well as during storage in cache locally over time

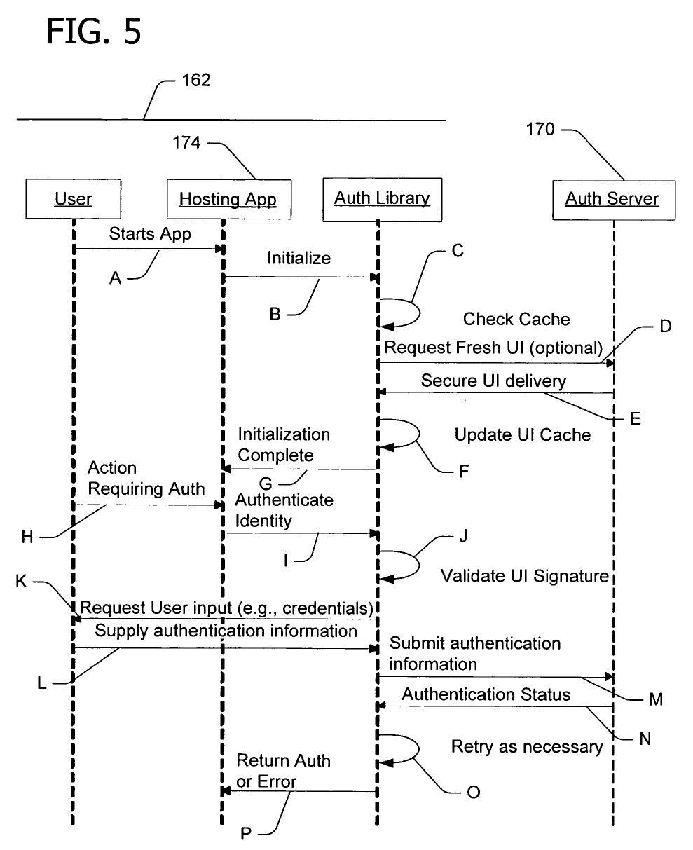

Referring now to FIG. 5, an exemplary flow diagram illustrates an implementation of the present invention and the interaction between server 170 and at least one of the clients 162. The lines in FIG. 5 labeled “A” through “P” represent the flow of information or activities during the process. The arrows on the lines indicate the direction of the process flow. In this example, the label “A” represents the beginning of the processes and the label “P” represents the end of the process.

As described above, the entire child window UI portion may be contained within client runtime library 176 as resources. These resources use typical web technologies such as HTML, JavaScript, etc. that are interpreted by the instance of a web browser control of client 162. The web browser control is pointed in this embodiment at the resource contents of client runtime library 176 locally on client 162, so direct network connectivity is not required to interact with the user. In one embodiment, client 162 periodically retrieves a DLL associated with user experience from central server 170 and cached locally for use. For security, the DLL may be signed to verify its source and to ensure that it has not been tampered with in transit or during storage in cache.

In the exemplary process of FIG. 5, aspects of the invention provide, among other things, an updatable user experience to be integrated with host application 174. Particularly, client runtime library 176 provides authentication services to its host application 174 on behalf of the authentication server. The look and feel, as well as the core interaction flow, may change for this authentication experience over time as the authenticating service changes its behavior. Advantageously, embodiments of the present invention accommodate these changes.

Process flow in FIG. 5 begins when host application 174 initializes client runtime library 176. Upon execution (see A), the host application 174 initializes client runtime library 176 (see B) and causes it to check a cache memory (e.g., cached on disk) of client 162 for an appropriate user experience DLL (see C). If needed, client 162, downloads the latest user experience DLL (e.g., UI DLL) from the authentication server (i.e., central server 170 ) (see D, E, F) via the data communication network 164. If a newer version of UI DLL happens to be present, client 162 will download it, verify its authenticity, and store it locally (e.g., stored securely in cache and locked for the duration of the run). In other words, the new UI DLL will bind to the UI client runtime library to prevent it from being tampered with for the duration. This enables the updated user experience to be integrated with host application 174. In this manner, embodiments of the invention also permit offline usage, which is different and better than a purely web-based user experience. The frequency of checking for updates is controlled by policy. This completes initialization of client runtime library 176 (see G).

When host application 174 requests an authentication (see H), client 162 drives its user experience from the new user experience DLL (see I). In this embodiment of the invention, host application 174 creates a parent window, instructs client runtime library 176 where to invoke the browser instance for its user experience as a child of the parent window, and instructs client runtime library 176 to begin the authentication process. Thus, the UI content can represent virtually any user experience that is desired to track changes in the identity, look, and feel, as well as fundamental changes to the authentication flow. For example, client runtime library 176 invokes a browser instance and points it to the user experience content embedded within the cached UI DLL.

In one embodiment of the invention, the client runtime can also mix online and offline user experience as appropriate. That is, if it is operated in a connected environment, the client runtime can start the user experience from the offline cached user experience and transition to content that is served live and direct from the authentication server, still within the client window that it is sharing underneath the hosting application. This back-and-forth model facilitates the ultimate in flexibility in managing the changing user experience.

The cached UI DLL drives the user experience by communicating with a binary client runtime library as necessary and informing it when the user has completed the experience. In this embodiment, a declarative form handles user experience but the binary library handles network communications with the authentication server. The contents of the UI DLL communicate with the binary components of client runtime library 176 by exposing an interface available to the script executing within the pages. The binary client runtime communicates with host application 174 and with the authentication server as necessary, and provides basic services to the web content running within the browser.

Referring further to FIG. 5, client 162 is then able to proceed with the authentication process by validating the UI signature (see J), requesting credentials from the user (see K), receiving the authentication information from the user (see L), and submitting it to authentication server 170 (see M). Authentication server 170 returns status information regarding the authentication (see N), retries if necessary (see O), and then returns notice of either authentication or error (see P).

Because it is based on general web technologies, the UI content can easily represent virtually any user experience that is desired to track changes in the identity, look and feel, and/or fundamental changes to the authentication flow. In contrast to the prior art, the architecture and process according to embodiments of the invention not only create and update the user experience but also integrate the authentication experience for an identity provider with a hosting application. In one embodiment, the client runtime library 176 may provide client-redistributable bits to affiliate sites 166 writing smart clients that wish to participate in a federated authentication service. The library eases the adoption of federated authentication and provides consistency across applications for a multi-site user authentication experience. The client runtime does not necessarily include any bits for the affiliate servers; the client runtime can deliver an authentication token to the hosting application, which in turn submits this token to the affiliate servers as proof of identity and perhaps authorization.

As described above, a smart client has code written and distributed to client 162 by affiliate server 166 that participates actively in authentication and authorization. Again, the smart client code is distributed to the vendor of application 162, which incorporates it and includes it in their direct distribution of 162 application. It is to be understood that they may or may not be the same vendor of the affiliate server. The affiliate server and application client may be unrelated other than the fact that they can communicate over a pre-agreed protocol that includes provisions for transiting an authentication token (to be provided from the client runtime). It can prove legitimate possession of a service ticket through an authenticator and use a session key to secure and/or prove communications. In contrast, a dumb client, or thin client, does not actively participate in authentication (e.g., a typical web browser visiting a site outside the enterprise). It neither provides an authenticator nor uses a session key based directly on the authentication. Dumb browsers can develop a session key for the transport layer, but it is a secure pipe between the applications that is independent of an authenticated user identity.

Embodiments of the invention described herein are particularly well suited for use in smart client scenarios.

Client applications using client runtime library 176 enable a more secure experience. Unlike browser-based authentication scenarios, they can prove legitimate possession of a service ticket through an authenticator and can use the associated session key to encrypt and/or prove communications. Client runtime library 176 may also take prudent measures to protect credentials and other sensitive resources that it handles on behalf of hosting applications. Thus, errors in client application code exposing vulnerabilities can be avoided.

The client runtime library 176 supports a flexible user interface that can be updated by central server 170 without requiring a binary distribution of client runtime library code. As an example, client runtime library 176 hosts a web browser component to provide this flexibility. It may also include, for example, a simple Win32-based implementation of username/password in the event that it has trouble instantiating the browser control for some reason to enable basic authentication. Any other declarative user interface technology may also be a suitable fit for this architecture.

In one embodiment of the invention, the browser control of host application 174 obtains its content using res: URL's from a user interface DLL (CRLui.DLL) that is downloaded from central server 170 by client runtime 176 during the update process. This DLL contains resources (including JavaScript code as necessary) rather than binary executable code. As described above, the DLL may be cryptographically signed by a certificate. Client runtime library 176 verifies this signature before each use of the DLL. In an alternative embodiment, a public key and signature may be used in the XML configuration file. This CRLui.DLL is a shared component between all applications using client runtime library 176 stored in, for example, %SYSTEMROOT%\System32\Passport. This component may be either shared or unique to each client application that uses it at the discretion of the vendor of the client application.

Although CRLui.DLL is updated from central server 170, an initial version may be installed with hosting application 174.

The script/HTML contained in client runtime library ui.DLL that runs in the embedded browser is responsible for collecting all credentials from the user and providing them back to the binary client runtime library code, which will package them up for submission as part of the authentication request. An example of UI code accessing client runtime library 176 follows:

```
<SCRIPT LANGUAGE=“VBJScript”>
    window.external.SetUsername(user)
    window.external.AddCredential(pwd)
    window.external.Submit(credType)
</SCRIPT>
```

Script Interface Back to client runtime library 176: The interface that is made available to the script running in the hosted browser instance allows access to configuration parameters, storage of credentials and control of the server communication flow. The data types are compatible with OLE Automation types to be accessible to the scripting engine (via an IDispatch implementation). For example:

```
// All Dispatch Accessible
[propget] client runtime library(OUT lDispatch ** pDispatch);
HRESULT CloseWindow(
  IN HRESULT LastErrorCode);
HRESULT SetCertificate(
  IN ICertificate* Certificate);
HRESULT AddCredential(
  IN BSTR CredType,
  IN BSTR CredValue,
  IN VARIANT_BOOL Persist,
  IN VARIANT_BOOL UseSavedCredential);
HRESULT HasSavedCredentials(
  IN BSTR CredType,
  OUT VARAINT_BOOL HasSavedCreds);
HRESULT Add PrivateData(
  IN BSTR Name,
  IN BSTR Value);
HRESULT SetPassportHeader(
  IN IXMLDOMDocument2* Header);
HRESULT Submit(
  IN BSTR CredType);
HRESULT SaveUserName( );
HRESULT ClearUserName( );
```

According to embodiments of the present invention, client runtime library 176 is a property that returns a component with configuration properties on it. These properties provide the UI script with various attributes of its environment and client runtime library binaries under which it is running. APPENDIX A shows exemplary client runtime library environmental properties.

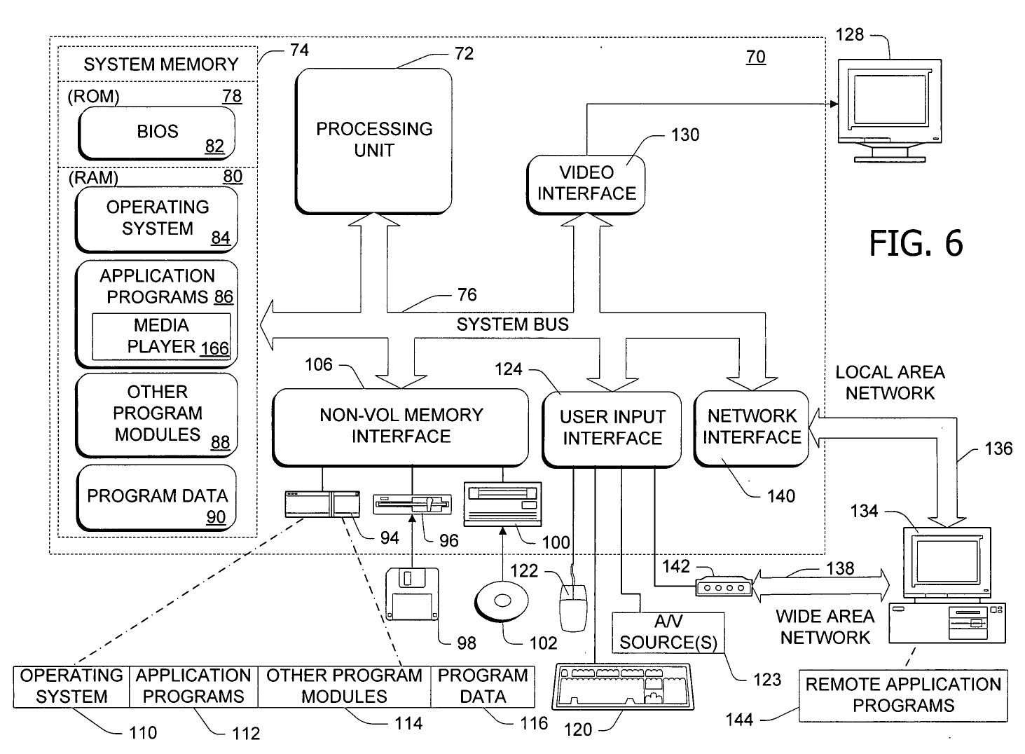

FIG. 6 shows one example of a general purpose computing device in the form of a computer 70. In one embodiment of the invention, a computer such as the computer 70 is suitable for use in enabling an updated user experience to be integrated with a host application 174.

In the illustrated embodiments, computer 70 has one or more processors or processing units 72 and a system memory 74. In the illustrated embodiment, a system bus 76 couples various system components including the system memory 74 to the processors 72. The bus 76 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 70 typically has at least some form of computer readable media. Computer readable media, which include both volatile and nonvolatile media, removable and non-removable media, may be any available medium that may be accessed by computer 70. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by computer 70. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of the any of the above are also included within the scope of computer readable media.

The system memory 74 includes computer storage media in the form of removable and/or non-removable, volatile and/or nonvolatile memory. In the illustrated embodiment, system memory 74 includes read only memory (ROM) 78 and random access memory (RAM) 80. A basic input/output system 82 (BIOS), containing the basic routines that help to transfer information between elements within computer 70, such as during start-up, is typically stored in ROM 78. The RAM 80 typically contains data and/or program modules that are immediately accessible to and/or presently being operated on by processing unit 72. By way of example, and not limitation, FIG. 6 illustrates operating system 84, application programs 86, other program modules 88, and program data 90.

The computer 70 may also include other removable/non-removable, volatile/nonvolatile computer storage media. For example, FIG. 6 illustrates a hard disk drive 94 that reads from or writes to non-removable, nonvolatile magnetic media. FIG. 6 also shows a magnetic disk drive 96 that reads from or writes to a removable, nonvolatile magnetic disk 98, and an optical disk drive 100 that reads from or writes to a removable, nonvolatile optical disk 102 such as a CD-ROM or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 84, and magnetic disk drive 96 and optical disk drive 100 are typically connected to the system bus 76 by a non-volatile memory interface, such as interface 106.

The drives or other mass storage devices and their associated computer storage media discussed above and illustrated in FIG. 6, provide storage of computer readable instructions, data structures, program modules and other data for the computer 70. In FIG. 6, for example, hard disk drive 94 is illustrated as storing operating system 110, application programs 112, other program modules 114, and program data 116. Note that these components can either be the same as or different from operating system 84, application programs 86, other program modules 88, and program data 90. Operating system 110, application programs 112, other program modules 114, and program data 116 are given different numbers here to illustrate that, at a minimum, they are different copies.

A user may enter commands and information into computer 70 through input devices or user interface selection devices such as a keyboard 120 and a pointing device 122 (e.g., a mouse, trackball, pen, or touch pad). Other input devices (not shown) may include a microphone, joystick, game pad, satellite dish, scanner, or the like. These and other input devices are connected to processing unit 72 through a user input interface 124 that is coupled to system bus 76, but may be connected by other interface and bus structures, such as a parallel port, game port, or a universal serial bus (USB). A monitor 128 or other type of display device is also connected to system bus 76 via an interface, such as a video interface 130. In addition to the monitor 128, computers often include other peripheral output devices (not shown) such as a printer and speakers, which may be connected through an output peripheral interface (not shown).

The computer 70 may operate in a networked environment using logical connections to one or more remote computers, such as a remote computer 134. The remote computer 134 may be a personal computer, a server, a router, a network PC, a peer device or other common network node, and typically includes many or all of the elements described above relative to computer 70. The logical connections depicted in FIG. 6 include a local area network (LAN) 136 and a wide area network (WAN) 138, but may also include other networks. LAN 136 and/or WAN 138 may be a wired network, a wireless network, a combination thereof, and so on. Such networking environments are commonplace in offices, enterprise-wide computer networks, intranets, and global computer networks (e.g., the Internet).

When used in a local area networking environment, computer 70 is connected to the LAN 136 through a network interface or adapter 140. When used in a wide area networking environment, computer 70 typically includes a modem 142 or other means for establishing communications over the WAN 138, such as the Internet. The modem 142, which may be internal or external, is connected to system bus 76 via the user input interface 134, or other appropriate mechanism. In a networked environment, program modules depicted relative to computer 70, or portions thereof, may be stored in a remote memory storage device (not shown). By way of example, and not limitation, FIG. 6 illustrates remote application programs 144 as residing on the memory device. The network connections shown are exemplary and other means of establishing a communications link between the computers may be used.

Generally, the data processors of computer 70 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. The invention described herein includes these and other various types of computer-readable storage media when such media contain instructions or programs for implementing the steps described herein in conjunction with a microprocessor or other data processor. The invention also includes the computer itself when programmed according to the methods and techniques described herein.

For purposes of illustration, programs and other executable program components, such as the operating system, are illustrated herein as discrete blocks. It is recognized, however, that such programs and components reside at various times in different storage components of the computer, and are executed by the data processor(s) of the computer.

Although described in connection with an exemplary computing system environment, including computer 70, the invention is operational with numerous other general purpose or special purpose computing system environments or configurations. The computing system environment is not intended to suggest any limitation as to the scope of use or functionality of the invention. Moreover, the computing system environment should not be interpreted as having any dependency or requirement relating to any one or combination of components illustrated in the exemplary operating environment. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. Generally, program modules include, but are not limited to, routines, programs, objects, components, and data structures that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

An interface in the context of software architecture includes a software module, component, code portion, or other sequence of computer-executable instructions. The interface includes, for example, a first module accessing a second module to perform computing tasks on behalf of the first module. The first and second modules include, in one example, application programming interfaces (APIs) such as provided by operating systems, component object model (COM) interfaces (e.g., for peer-to-peer application communication), and extensible markup language metadata interchange format (XMI) interfaces (e.g., for communication between web services).

The interface may be a tightly coupled, synchronous implementation such as in Java 2 Platform Enterprise Edition (J2EE), COM, or distributed COM (DCOM) examples. Alternatively or in addition, the interface may be a loosely coupled, asynchronous implementation such as in a web service (e.g., using the simple object access protocol). In general, the interface includes any combination of the following characteristics: tightly coupled, loosely coupled, synchronous, and asynchronous. Further, the interface may conform to a standard protocol, a proprietary protocol, or any combination of standard and proprietary protocols.

The interfaces described herein may all be part of a single interface or may be implemented as separate interfaces or any combination therein. The interfaces may execute locally or remotely to provide functionality. Further, the interfaces may include additional or less functionality than illustrated or described herein.

In operation, computer 70 executes computer-executable instructions such as those described herein for providing an updatable user interface for use with host application 174. Computer 70, operating as client 162 coupled to data communication network 164, executes host application 174 for providing a service to a user. Computer 70 receives a UI resource from central server 170 via the network 164 and stores it for use by client runtime library 176 in a cache memory. Computer 70 further operates a browser to render a first user interface component on the client based on the UI resource. The browser is responsive to the client runtime library to render the first user interface component when the user requests the service provided by the host application. In an alternative embodiment, computer 70 embodies central server 170.

The order of execution or performance of the methods illustrated and described herein is not essential, unless otherwise specified. That is, elements of the methods may be performed in any order, unless otherwise specified, and that the methods may include more or less elements than those disclosed herein.

Information in this document, including uniform resource locator and other Internet web site references, is subject to change without notice. Unless otherwise noted, the example companies, organizations, products, domain names, e-mail addresses, logos, people, places and events depicted herein are fictitious, and no association with any real company, organization, product, domain name, e-mail address, logo, person, place or event is intended or should be inferred.

When introducing elements of the present invention or the embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

APPENDIX A

| ConfigValueName | Description |
|---|---|
| Version | Version of the client binary client runtime library that is |
| | hosting the user interface. This field may be used for the |
| | authentication service to deliver a single ppclrui.DLL |
| | that is compatible with multiple deployed |
| | versions of the binary client runtime library. |
| Certificates | Collection of certificates available in the certificate |
| | store for this user on this machine. |
| LastServerResponse | Authentication-specific SOAP header element from |
| | the last response received from the authentication |
| | service, if any. If the authentication server was not a |
| | specific service or if there has not yet been a |
| | message sent to the authentication service during |
| | this authentication session, this is empty. This data |
| | effectively allows the user interface script in client |
| | runtime libraryui.DLL to have a rich dialogue with the |
| | authentication service to enable more elaborate |
| | credential flows. |
| HostOS | Operating system under which the client runtime |
| | library is running. |
| SupportsPersistentCredentials | Returns a Boolean indicating whether or not the |
| | platform supports secure storage of private |
| | credentials. The UI script should use this to hide |
| | ‘Sign Me in Automatically’-type options when |
| | appropriate. |
| HostingAppGuid | Provides the client application GUID that was given |
| | to the client runtime library when it was initialized. |
| | This allows the UI to tune itself to particular |
| | applications if necessary. |
| Username | This property is used to set/get the current user |
| Cookie(<cookie name>) | This property is a name/value pair mapping |
| Config(<config name>) | This property is a name/value pair mapping for the |
| | configuration |
| Lcid | The locale id of the current instance of the client |
| | runtime library |
| ErrorCodeBase(<base | Retrieves the base of HRESULT for the given error |
| name>) | code type name |
| ChallengeCode | Retrieves the challenge code used to render the UI. |
| | This is used to show the correct challenge UI for the |
| | user (i.e. force sign-in, pin sign-in, certs, etc.) |

The Username property allows the user interface script to set up the identity that is being authenticated. Other credentials collected during the authentication session are associated with this Username. Once the credentials are validated by the authentication server, they will be moved into the credential cache for the process. If any of the credentials are persistent they will also be stored in the credential store at this point.

AddCredential stores a credential associated with the identity. Identity credentials are those that prove identity (e.g., password, pin, etc.). Non-identity credentials are private data that do not prove identity but that still need to be protected (e.g., human interaction protocol (HIP) challenge response, etc.).

StoreCookie/GetCookie implements a simple cookie-like mechanism. The system need not rely on the browser's cookie mechanism because it is being served locally. This also removes the dependency that the authentication protocol be implemented in terms of HTTP in order to get its persistent request (e.g., cookie) state support.

Submit is called when the script is ready for the stored credentials to be presented to the authentication server. The client runtime library binary code packages up the credentials that the script has accumulated and submit to a security token service.

1. A method of providing an updatable user interface for use with a host application, said host application being executed by a client coupled to a data communication network for providing a service to a user, said method comprising:
receiving a user interface (UI) resource for use by a client runtime library, said UI resource being received by the client via the data communication network from a central server, said central server also being coupled to the data communication network;
updating a cache memory with the received UI resource, said cache memory being associated with the client and accessible by the client runtime library; and
causing a first user interface component to be rendered on the client based on the UI resource in response to the client runtime library when the user requests the service provided by the host application.

2. The method of claim 1, wherein causing the first user interface component comprises operating a browser to render the first user interface component, said browser being responsive to the client runtime library to render the first user interface component when the user requests the service provided by the host application.

3. The method of claim 1, wherein the first user interface component includes a first window managed by the UI resource for requesting information from the user.

4. The method of claim 3, further comprising rendering a second user interface component on the client independent of the UI resource, said second user interface component including a second window managed by the host application.

5. The method of claim 3, wherein the first window managed by the UI resource for requesting information from the user comprises a sign-in module for receiving authentication credentials from the user.

6. The method of claim 5, further comprising submitting the received credentials to the central server for authentication, said central server comprising an authentication service.

7. The method of claim 1, further comprising hosting, by the client runtime library, a web browser component for rendering the first user interface component based on the UI resource.

8. The method of claim 1, further comprising:
determining whether an updated UI resource is available;
requesting the available updated UI resource from the central server via the data communication network; and
updating the cache memory with the received updated UI resource.

9. The method of claim 1, further comprising verifying the received UI resource with a digital signature.

10. The method of claim 9, further comprising re-verifying the digital signature on the cached UI resource prior to a subsequent use.

11. The method of claim 1, wherein causing the first user interface component comprises instructing the client runtime library where to invoke a browser instance for the first user interface component as a child of a parent window.

12. One or more computer-readable media having computer-executable instructions for performing the method of claim 1.

13. A method of authenticating a user of a host application, said host application being executed by a client coupled to a data communication network for providing a service to the user, said method comprising:
receiving, at a central server, a request for a user interface (UI) resource, said UI resource being for use by a client runtime library of the host application, said central server also being coupled to the data communication network and said request being received from the client via the data communication network;
sending the UI resource to the client via the data communication network, said UI resource being stored in a cache memory associated with the client and accessible by the client runtime library;
receiving authentication credentials from the user in response to a first user interface component rendered on the client when the user requests the service provided by the host application, said first user interface component being based on the UI resource and managed by the client runtime library; and
comparing the received credentials with authentication information maintained in an authentication database associated with the central server to authenticate the user.

14. The method of claim 13, further comprising:
determining whether an updated UI resource is available;
sending the available updated UI resource from the central server to the client via the data communication network; and
causing the cache memory to be updated with the updated UI resource.

15. The method of claim 13, further comprising operating a browser to render the first user interface component on the client based on the UI resource, said browser being responsive to the client runtime library to render the first user interface component when the user requests the service provided by the host application

16. The method of claim 15, wherein operating the browser to render the first user interface component comprises instructing the client runtime library where to invoke a browser instance for the first user interface component as a child of a parent window.

17. The method of claim 13, wherein the first user interface component includes a first window managed by the UI resource for requesting the authentication credentials from the user.

18. The method of claim 17, further comprising rendering a second user interface component on the client independent of the UI resource, said second user interface component including a second window managed by the host application.

19. The method of claim 17, wherein the first window comprises a sign-in module.

20. The method of claim 13, wherein sending the updated UI resource to the client includes digitally signing the UI resource.

21. One or more computer-readable media having computer-executable instructions for performing the method of claim 13.

22. One or more computer-readable media having stored thereon a data structure comprising:
a client runtime library for use with a host application, said host application being executable by a client coupled to a data communication network for providing a service to a user;
a user interface (UI) resource for use by the client runtime library, said UI resource being received by the client via the data communication network from a central server, said central server also being coupled to the data communication network; and
a browser for rendering a first user interface component on the client based on the UI resource, said browser being responsive to the client runtime library to render the first user interface component when the user requests the service provided by the host application.

23. The computer-readable media of claim 22, wherein the first user interface component includes a first window managed by the UI resource for requesting information from the user.

24. The computer-readable media of claim 23, further comprising a second user interface component rendered on the client independent of the UI resource, said second user interface component including a second window managed by the host application.

25. The computer-readable media of claim 23, wherein the first window managed by the UI resource for requesting information from the user comprises a sign-in module for receiving authentication credentials from the user.

26. The computer-readable media of claim 25, further comprising submitting the received credentials to the central server for authentication, said central server comprising an authentication service.

27. The computer-readable media of claim 22, wherein said received UI resource is stored in a cache memory associated with the client and accessible by the client runtime library.

28. The computer-readable media of claim 27, further comprising an updated UI resource requested from the central server by the client for changing the first user interface component, said updated UI resource being stored in the cache memory.

29. The computer-readable media of claim 22, further comprising a digital signature on the received UI resource.
